(19) United States
(12) Patent Application Publication
(10) Pub. No.: US 2008/0215490 A1
(43) Pub. Date: Sep. 4, 2008

(54) INTELLIGENT ASSISTANT FOR CONTENT PURCHASING

(75) Inventors: Jason N. Howard, Alpharetta, GA (US); Alfred N. Danial, Lake Zurich, IL (US); Scott B. Davis, Walworth, WI (US); Thomas J. MacTavish, Inverness, IL (US); Yan Ming Cheng, Inverness, IL (US); Thomas J. Weigert, Palatine, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/681,764

(22) Filed: Mar. 3, 2007

(51) Int. Cl. H04L 9/32

(52) U.S. Cl. 705/51; 700/28

(57) ABSTRACT

A method, apparatus, and electronic device for optimizing content acquisition are disclosed. A memory may store usage of a previous set of media content by the mobile device. An input/output device may receive a request for a current set of media content. A processor may create a user profile based on the usage and provides a first recommendation of a first digital rights agreement based on the user profile.

### 1. FIELD OF THE INVENTION

The present invention relates to a method and system for purchasing content with mobile telecommunication devices. The present invention further relates to determining an optimum content distribution agreement when purchasing content.

### 2. INTRODUCTION

Modern mobile telecommunications devices, such as cellular telephones, may download a variety of media content. This media content may include such media types as text, pictures, audio, video, and other types of media. The media content may be any of a variety of formats, such as standards provided by Moving Picture Experts Group (MPEG) (Including MPEG 1, Layer 3 (MP3)), standards provided by Joint Photographic Experts Group (JPEG), Portable Document Format (PDF), and others.

As this content is downloaded, a digital rights agreement has to be established. These digital rights agreements may include any manner of licenses, allowing the user to buy or rent the digital media content. Each of these digital rights agreements has their own sets of rules and conditions that may affect the efficiency or desirability of the media transfer. Often, a user does not have the capability or the time to sort through the available options in a time efficient manner.

### SUMMARY OF THE INVENTION

A method, apparatus, and electronic device for optimizing content acquisition are disclosed. A memory may store usage of a previous set of media content by the mobile device. An input/output device may receive a request for a current set of media content. A processor may create a user profile based on the usage and provides a first recommendation of a first digital rights agreement based on the user profile.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a network for downloading digital media content to a mobile telecommunications device.

FIG. 2 illustrates in a block diagram a user profile that may be used by a mobile telecommunications device in selecting a license and a digital media content source.

FIG. 3 illustrates in a flowchart one embodiment of a method for recommending digital media content sources to a mobile telecommunications device seeking content.

FIG. 4 illustrates in a flowchart one embodiment of a method for adjusting the user license profile based upon content usage.

FIG. 5 illustrates a possible configuration of a computer system to act as a mobile system or location server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for optimizing content acquisition are disclosed. A memory may store usage of a previous set of media content by the mobile device. An input/output device may receive a request for a current set of media content. A processor may create a user profile based on the usage and provides a rights recommendation of a first digital rights agreement based on the user profile.

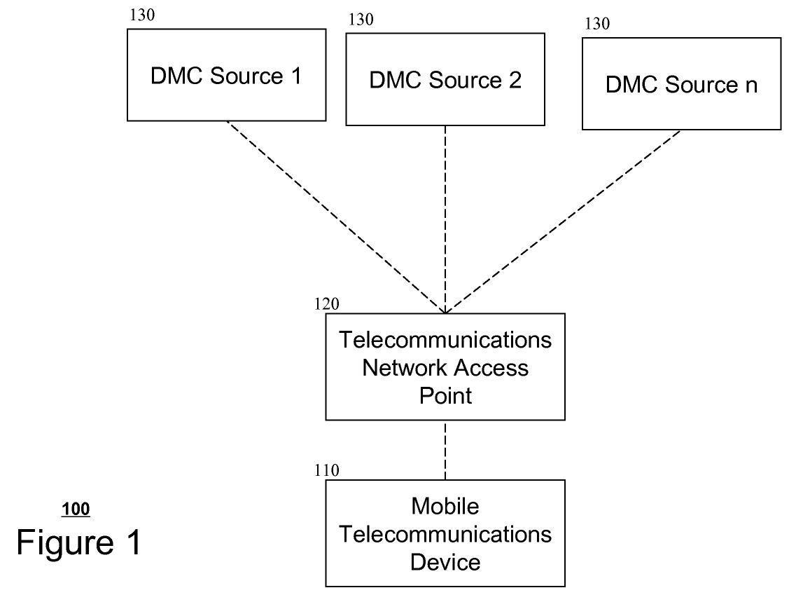

FIG. 1 illustrates in a block diagram one embodiment of a network 100 for downloading digital media content (DMC) to a mobile telecommunications device (MTD). A MTD 110 is a mobile apparatus or electronic device that may perform a telecommunications function, such as a cellular telephone, laptop computer, or other communications device. The MTD 110 may access a network through a telecommunications network access point 120, such as a wireless telephone cell. The MTD 110 may download a set of digital media content (DMC) from a DMC source 130, such as a website, or have DMC loaded onto it via a removable data storage medium. The DMC may be text, picture, audio, video, or some other form of media. The DMC may be in any number of formats, such as standards provided by Moving Picture Experts Group (MPEG) (Including MPEG 1, Layer 3 (MP3)), standards provided by Joint Photographic Experts Group (JPEG), Portable Document Format (PDF), and other standards. Multiple DMC sources 130 may be available to provide DMC to the MTD 110.

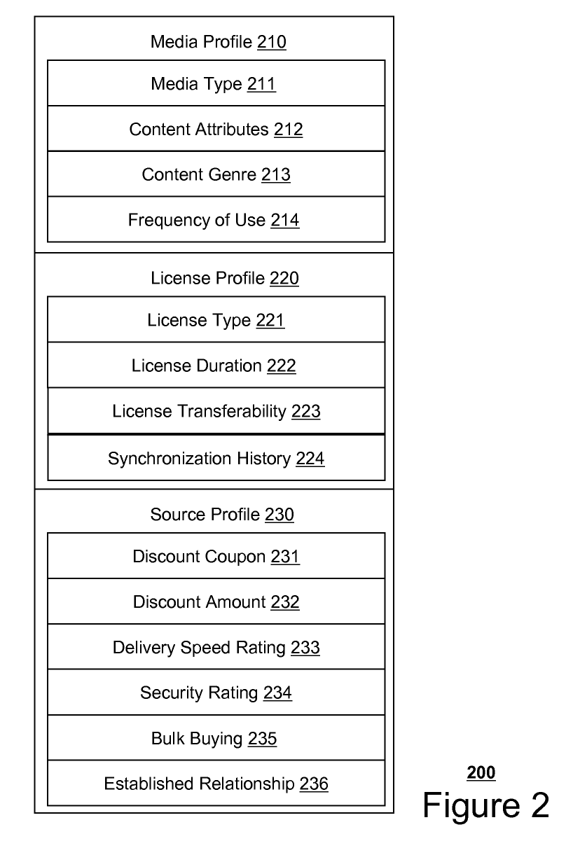

FIG. 2 illustrates in a block diagram a user profile 200 that may be used by a MTD 110 in selecting a license and a DMC source 130. A user profile 200 may contain a number of profiles categorizing different aspects of the user's DMC habits, such as a media profile 210, a license profile 220, and a source profile 230.

The media profile 210 may be used to track a user preference in DMC. Further the media profile may be used to index the license profile 220 and the source profile 230, as a user's preference in license and source is going to be the most uniform across similar media. A media profile 210 may track the many different kinds of digital media used by the MTD 110. The media profile 210 may include a field 211 tracking the media types used by the MTD 110, such as text, audio, pictures, video, and other media types. A media profile 210 may include a field 212 tracking the content attributes of the DMC The contents attributes may be any features of the DMC that affect its use by the MTD 110, such as format, length, cross platform portability, and other features. A media profile 210 may include a field 213 tracking the content genres. Examples of genres may include rock, country, rap, spoken word, audio books, and others for audio; science fiction, mystery, thriller, biography, history, and religion for text; or action, comedy, drama, mystery, or animated for video. A media profile 210 may include a field 214 to track the frequency of use of that media. The frequency of use field 214 may store a simple count of the number of times a particular media is used, or a count averaged over a set period of time.

The license profile 220 may be used to determine the best type of license for a user based on past licensing choices and the user's actual usage of the DMC. A license profile 220 may contain a field 221 that tracks the license type normally used when downloading DMC, such as a rental agreement (i.e. a temporary digital rights agreement) or a purchase agreement (i.e. a permanent digital rights agreement). The license type may be further adjusted by factoring the frequency of use. This adjustment may reflect that even though a user may often opt to purchase DMC, the level of usage indicates that the user would be better off renting the DMC. A license profile 220 may contain a field 222 that tracks the license duration normally used. Again, the license duration may be further adjusted by factoring the frequency of use. A license profile 220 may contain a field 223 that tracks if a user normally purchases licenses that are transferable. This option allows users to purchase DMC as a gift, such as for a relative below the age of majority, like a son or daughter, and preview the content themselves before transferring the DMC to that minor aged relative. A license profile 220 may contain a field 224 that tracks if a user tends to synchronize the DMC with the user's media library. The DMC, residing on, for example, the MTD 110, may be synchronized with the user's media library, residing on, for example, a user's personal computer, or vice versa. Such synchronization may affect the licensing of the DMC.

The source profile 230 may be used to track past source choices by the user and to determine which factors are most important to that user in determining a DMC source 130. A source profile 230 may contain a field 231 that tracks the frequency of use of discount coupons in licensing DMC. A second field 232 may track the amount of the discount, either tracking the average discount of the coupons used, or tracking a minimum discount used. A source profile 230 may contain a field 233 that tracks the delivery speed of the DMC source 130, possibly storing a ranking of the content delivery speed of the DMC source 130 among the options presented. A source profile 230 may contain a field 234 that tracks the security of the DMC source 130, possibly storing a ranking of the security of the DMC source 130 among the options presented. A source profile 230 may contain a field 235 that tracks the frequency of use of bulk buying in licensing DMC. A source profile 230 may contain a field 236 that tracks whether a user has a tendency to purchase from a single source, possibly because of an established user-source relationship. Established relationships may be tracked by storing the identity of all DMC sources 130 used within a set period of time, and purging all DMC sources 130 that are not used above a set threshold.

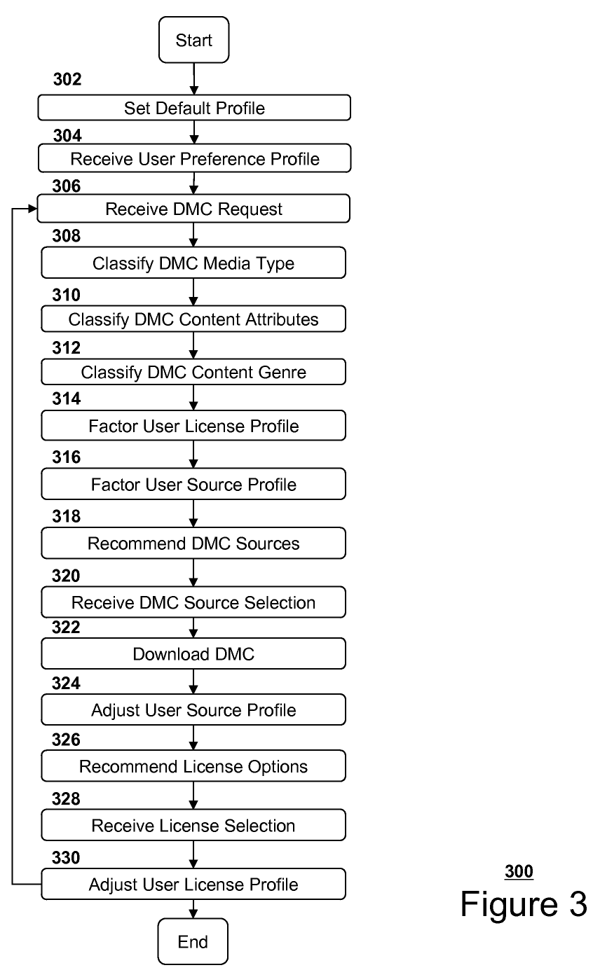

FIG. 3 illustrates in a flowchart one embodiment of a method 300 for recommending DMC sources 130 to an MTD 110 seeking content. The MTD 110 may set a default profile for the user (Block 302). This default profile may be based on a statistical average based on past customer use. The MTD 110 may receive a more specific user preference profile from the user (Block 304). This user preference profile may be built using a series of queries to the user on first use of the MTD 110 to download DMC. The MTD 110 may receive from the user a request for DMC (Block 306). The MTD 110 may classify the media type of the DMC requested (Block 308). The MTD 110 may classify the content attributes of the DMC requested (Block 310). The MTD 110 may classify the content genre of the DMC requested (Block 312). For a general request for DMC, a specific set of DMC may be recommended to the user based upon available DMC when factored with the user's media profile 210. The MTD may factor in the user license profile 220 (Block 314) and the user source profile 230 (Block 316) with the media classifications to recommend a set of DMC sources 130 to the user for downloading the requested DMC (Block 318). In the absence of competing interests, security, download speed, and cost reducing factors, such as discounts and bulk buying, may be used to establish a set of criteria in determining a source recommendation even in the absence of such concerns in a user source profile. The MTD 110 may then receive a selection by the user of the chosen DMC source 130 (Block 320). The MTD 110 may download the DMC from the selected DMC source 130 (Block 322). The MTD 110 may adjust the user source profile 230 based upon the characteristics of the selected DMC source 130 (Block 324). If the selected DMC source 130 allows for a range of licensing options, the MTD 110 may recommend to the user a set of licensing options based on the user license profile 220 (Block 326). The MTD 110 may receive from the user a selection of the chosen license option (Block 328). The MTD 110 may then adjust the user license profile 220 based upon the selected licensing option (Block 330). If the selected DMC source 130 has a single fixed licensing option, the MTD adjusts the user license profile 220 based upon that single licensing option (Block 330).

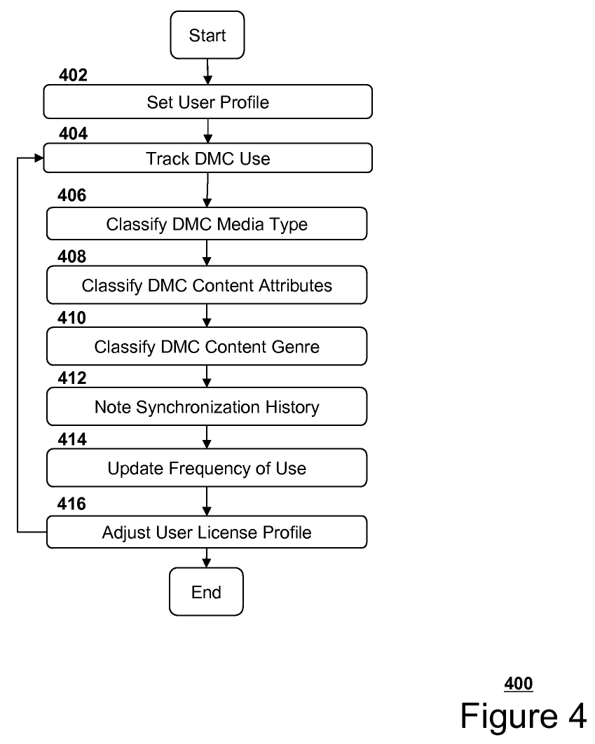

FIG. 4 illustrates in a flowchart one embodiment of a method 400 for adjusting the user license profile 220 based upon content usage. The MTD 110 may set the user profile, based upon purchasing choices (Block 402). The MTD 110 may track the use of the DMC by the user (Block 404). This tracking may be simple as noting a use of a DMC or factoring in the frequency with which that DMC is used. The MTD 110 may classify the media type of the DMC requested (Block 406). The MTD 110 may classify the content attributes of the DMC requested (Block 408). The MTD 110 may classify the content sub-genre of the DMC requested (Block 410). The MTD 110 may note any synchronization that takes place (Block 412). The MTD 110 may update the frequency of use field 214 for that sub-group of DMC (Block 414). The MTD 110 may further adjust the other fields in the user license profile 220 based upon the frequency of use (Block 416).

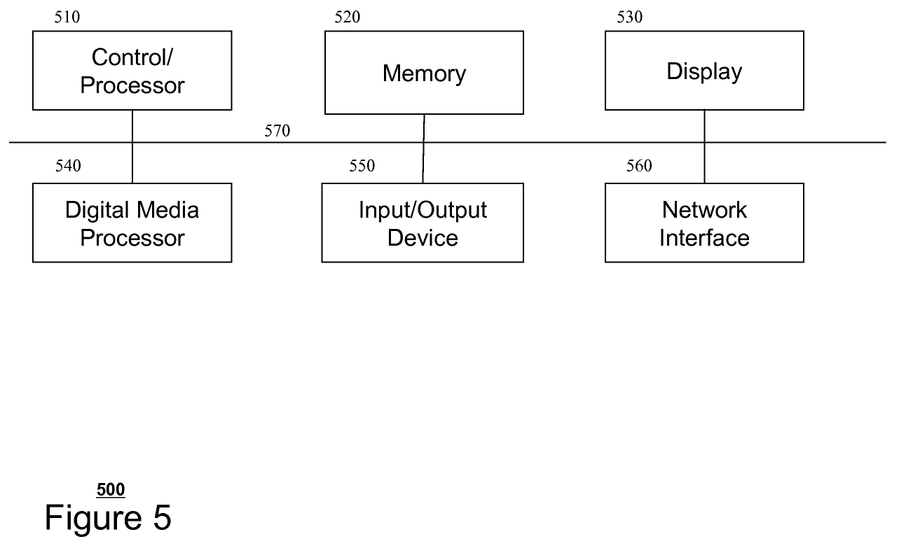

FIG. 5 illustrates a possible configuration of a computing system 500 to act as a mobile telecommunications apparatus or electronic device to execute the present invention. The computer system 500 may include a controller/processor 510, a memory 520, display 530, a digital media processor 540, input/output device interface 550, and a network interface 560, connected through bus 570. The computer system 500 may implement any operating system, such as Windows or UNIX, for example. Client and server software may be written in any programming language, such as ABAP, C, C++, Java or Visual Basic, for example.

The controller/processor 510 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 520 may include volatile and nonvolatile data storage, including one or more electrical, magnetic or optical memories such as a random access memory SAM), cache, hard drive, or other memory device. The memory may have a cache to speed access to specific data. The memory 520 may also be connected to a compact disc-read only memory (CD-ROM), digital video disc-read only memory (DVD-ROM), DVD read write input, tape drive or other removable memory device that allows media content to be directly uploaded into the system.

The digital media processor 540 is a separate processor that may be used by the system to more efficiently present digital media. Such digital media processors may include video cards, audio cards, or other separate processors that enhance the reproduction of digital media.

The Input/Output interface 550 may be connected to one or more input devices that may include a keyboard, mouse, pen-operated touch screen or monitor, voice-recognition device, or any other device that accepts input. The Input/Output interface 550 may also be connected to one or more output devices, such as a monitor, printer, disk drive, speakers, or any other device provided to output data.

The network interface 560 may be connected to a communication device, modem, network interface card, a transceiver, or any other device capable of transmitting and receiving signals over a network. The network interface 560 may be used to transmit the media content to the selected media presentation device. The network interface may also be used to download the media content from a media source, such as a website or other media sources. The components of the computer system 500 may be connected via an electrical bus 570, for example, or linked wirelessly.

Client software and databases may be accessed by the controller/processor 510 from memory 520, and may include, for example, database applications, word processing applications, the client side of a client/server application such as a billing system, as well as components that embody the decision support functionality of the present invention. The user access data may be stored in either a database accessible through the database interface 540 or in the memory 520. The computer system 500 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for optimizing content acquisition by a mobile device, comprising:
tracking usage of a previous set of media content by the mobile device;
creating a user profile based on the usage;
receiving a request for a current set of media content; and
providing a rights recommendation of a first digital rights agreement based on the user profile.

2. The method of claim 1, wherein the first digital rights agreement is a purchase agreement.

3. The method of claim 1, wherein the first digital rights agreement is a rental agreement.

4. The method of claim 1, further comprising determining a duration of the first digital rights agreement based on the user profile.

5. The method of claim 1, wherein the first digital rights agreement is transferable.

6. The method of claim 1, further comprising:
making a media classification of the previous set of media; and
factoring the media classification into the user profile.

7. The method of claim 6, wherein the media classification is based on media content type and media content attributes.

8. The method of claim 1, further comprising providing an alternate recommendation of a second digital rights agreement.

9. The method of claim 1, further comprising:
establishing a set of criteria based on the user profile; and
providing a source recommendation of a media content source for the current set of media based on the set of criteria.

10. The method of claim 9, wherein the set of criteria includes at least one of discount coupons, content delivery speed, transaction security, bulk-buying, and established user-source relationship.

11. A mobile telecommunications apparatus that downloads media content, comprising:
a memory that stores usage of a previous set of media content by the mobile device;
an input/output device that receives a request for a current set of media content; and
a processor that creates a user profile based on the usage and provides a rights recommendation of a first digital rights agreement based on the user profile.

12. The mobile telecommunications apparatus of claim 11, wherein the processor a duration of the first digital rights agreement based on the user profile.

13. The mobile telecommunications apparatus of claim 11, wherein the processor makes a media classification of the previous set of media and factors the media classification into the user profile.

14. The mobile telecommunications apparatus of claim 11, wherein the processor establishes a set of criteria based on the user profile and provides a source recommendation of a media content source for the current set of media based on the set of criteria.

15. The mobile telecommunications apparatus of claim 14, wherein the set of criteria includes at least one of discount coupons, content delivery speed, transaction security, bulk-buying, and established user-source relationship.

16. An electronic device that downloads media content, comprising:
a memory that stores usage of a previous set of media content by the mobile device;
an input/output device that receives a request for a current set of media content; and
a processor that creates a user profile based on the usage and provides a rights recommendation of a first digital rights agreement based on the user profile.

17. The electronic device of claim 16, wherein the processor a duration of the first digital rights agreement based on the user profile.

18. The electronic device of claim 16, wherein the processor makes a media classification of the previous set of media and factors the media classification into the user profile.

19. The electronic device of claim 16, wherein the processor establishes a set of criteria based on the user profile and provides a source recommendation of a media content source for the current set of media based on the set of criteria.

20. The electronic device of claim 19, wherein the set of criteria includes at least one of discount coupons, content delivery speed, transaction security, bulk-buying, and established user-source relationship.
